(19) United States
(12) Patent Application Publication
(10) Pub. No.: US 2010/0186417 A1
(43) Pub. Date: Jul. 29, 2010

(54) USE OF INERT GASES FOR SHIELDING OXIDIZER AND FUEL

(76) Inventors: Malte Blomeyer, Mulheim an der Ruhr (DE); Olga Deiss, Dusseldorf (DE); Andre Kluge, Dulmen (DE); Thomas Kunadt, Essen (DE); Berthold Köstlin, Duisburg (DE); Martin Lenze, Essen (DE); Paul Pixner, Munster / Westf (DE); Uwe Sieber, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/665,970

(22) PCT Filed: Jul. 3, 2008
(86) PCT No.: PCT/EP2008/058544

§ 371 Date: Dec. 22, 2009

(30) Foreign Application Priority Data
Jul. 10, 2007 (EP) 07013518.1

(51) Int. Cl. F02C 7/22; B05B 7/04; F23D 11/38

(52) U.S. Cl. 60/772; 431/2; 239/398; 431/160

(57) ABSTRACT

A method for protecting a burner from being heated excessively during the combustion of a fuel in a combustion chamber is provided. The fuel is injected through a fuel nozzle at the same time as an inert gas in the surroundings of the injected fuel is injected into the combustion chamber in such a manner that the fuel is separated spatially from an oxidizer by the inert gas until an ignitable mixture of the fuel is produced.

### CROSS REFERENCE TO RELATED APPLICATIONS

This application is the US National Stage of International Application No. PCT/EP2008/058544, filed Jul. 3, 2008 and claims the benefit thereof. The International Application claims the benefits of German application No. 07013518.1 EP filed Jul. 10, 2007, both of the applications are incorporated by reference herein in their entirety.

### FIELD OF INVENTION

The present invention relates to the protection of a burner from excessive heating during combustion of a fuel.

### BACKGROUND OF INVENTION

When fuel is combusted using a burner, the burner employed is in many cases strongly heated by combustion occurring too close to the burner. This applies particularly to combustion processes which take place e.g. in combustion chambers of gas turbines. Excessively high temperatures damage the burner or more precisely the burner components and reduce their useful life.

To protect the burner and its components, cooling is often provided. One widely used method of cooling is to cover the component surfaces affected with a film of cooling air. Another possibility is to coat the surface of the component with special ceramics. As a defined fuel/air mixture is required for combustion, swirler vanes are sometimes also used to mix the fuel uniformly with the air and thus prevent hot spots during combustion.

Particularly high temperatures occur during combustion of hydrogen as a fuel. Moreover, hydrogen is much more readily ignitable than other fuels, which increases the risk of ignition too close to the burner.

### SUMMARY OF INVENTION

The object of the present invention is to provide a method for protecting a burner from excessively strong heating during combustion of a fuel. Other objects of the present invention are to provide an advantageous fuel nozzle, an advantageous burner and an advantageous gas turbine.

These objects are achieved by a method for protecting a burner as claimed in the claims, a fuel nozzle as claimed in the claims, a burner as claimed in the claims and a gas turbine as claimed in the claims. The dependent claims contain advantageous embodiments of the invention.

The inventive method for protecting a burner from excessive heating during combustion of a fuel in a combustion chamber is characterized in that the fuel is sprayed in through a fuel nozzle and an inert gas is simultaneously injected into the combustion chamber in the area surrounding the injected fuel such that the fuel is spatially separated from an oxidizer by the inert gas until a ignitable mixture is produced. The fuel and the inert gas are therefore simultaneously injected into the combustion chamber, the inert gas surrounding the fuel such that the inert gas forms a protective layer around the fuel. The fuel does not therefore come into contact with a gas possibly containing oxygen as an oxidizer in the combustion chamber in the immediate vicinity of the burner. In this way, no ignitable mixture of fuel and oxidizer is formed close to the burner.

Inert gases are defined as gases which are very non-reactive, i.e. are involved in few chemical reactions. The inert gases include, for example, nitrogen, steam, carbon dioxide, and all the noble gases. The inert gas used in the context of the present invention can be e.g. nitrogen, carbon dioxide, a noble gas, i.e. helium, argon, neon, krypton, radon, xenon, or a mixture thereof.

The inventive spatial shielding of the fuel from an oxidizer by the inert gas also enables hydrogen to be used as a fuel. Due to the fact that combustion does not take place directly at the fuel nozzle, the burner or more precisely the burner's components are not subjected to the high temperatures produced during combustion of, in particular, hydrogen. Instead of hydrogen, other suitable fuels such as e.g. petroleum, natural gas or synthesis gas can of course also be used as fuels.

The inert gas used in the context of the present invention can preferably be injected into the combustion chamber through an inlet port annularly encircling the fuel inlet port of the fuel nozzle so that the stream of fuel is completely enclosed by a shroud of inert gas, it being advantageous for the inert gas inlet port to be located as close as possible to the fuel nozzle.

To produce an ignitable mixture, the oxidizer used can also be injected into the combustion chamber remotely from the fuel nozzle, thereby enabling the location of ignition to be monitored and influenced. This enables both the flame and the spatial position of the mixing zone to be controlled.

The present invention can be used in particular in the context of operating a gas turbine.

The fuel nozzle according to the invention comprises at least one fuel inlet port encircled by an inert gas inlet port and which enables the fuel to be spatially separated from an oxidizer by injection of an inert gas.

The fuel inlet port can be completely, i.e. annularly, encircled by the inert gas inlet port. The fuel inlet port can also be concentrically encircled by the inert gas inlet port. The inert gas inlet port can also consist of a plurality of individual ports disposed around the fuel inlet port.

The advantage of the fuel nozzle according to the invention is that fuel and oxidizer are initially spatially separated from one another, thereby enabling combustion to be controlled. Due to the fact that combustion does not take place in the immediate vicinity of the burner, the burner is not directly exposed to the high temperatures produced during combustion, thereby protecting the material of the burner and its components and extending their useful life.

A burner according to the invention comprises at least one fuel nozzle according to the invention.

A gas turbine according to the invention is equipped with at least one burner according to the invention.

### BRIEF DESCRIPTION OF THE DRAWINGS

Further features, characteristics and advantages of the present invention will now be described on the basis of exemplary embodiments and with reference to the accompanying drawings in which

FIG. 1 shows a longitudinal section through a fuel nozzle according to the invention.

FIG. 2 shows a cross section through a fuel nozzle according to the invention.

FIG. 3 shows a cross section through an alternative fuel nozzle according to the invention.

### DETAILED DESCRIPTION OF INVENTION

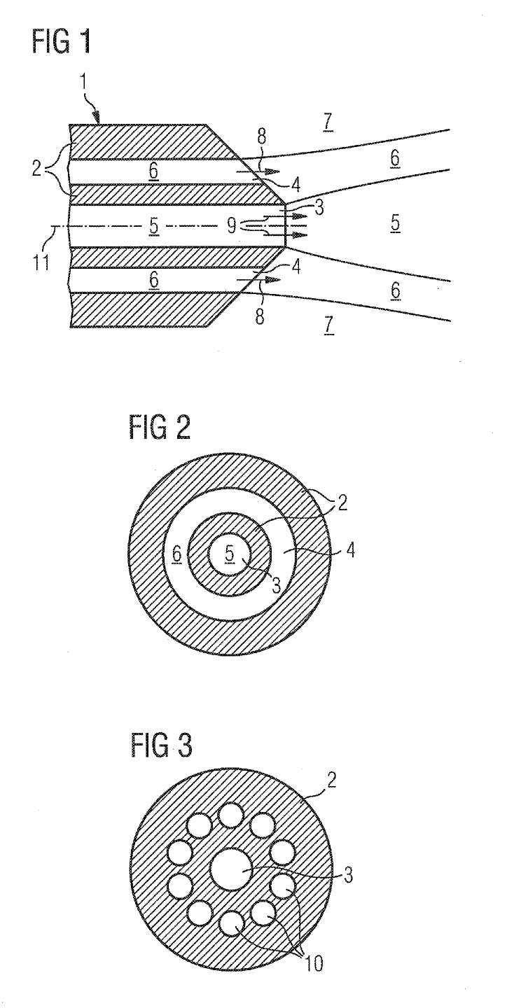

A first exemplary embodiment of the invention will now be explained in grater detail with reference to FIGS. 1 and 2. FIG. 1 shows a section along the longitudinal axis 11 through a fuel nozzle according to the invention. The fuel nozzle can be, for example, part of a combustion chamber of a gas turbine.

The fuel nozzle 1 has a housing 2 in which are located a fuel inlet port 3 and an inert gas inlet port 4, said fuel inlet port 3 being disposed parallel to the longitudinal axis 11 in the center of the burner nozzle 1. The inert gas inlet port 4 is located farther from the longitudinal axis 11 than the fuel inlet port 3. It likewise runs parallel to the longitudinal axis 11 and encloses the fuel inlet port 3 concentrically in an annular manner, the inert gas inlet port 4 and the fuel inlet port 3 being separated from one another by part of the housing 2.

The fuel nozzle 1 is located in a combustion chamber into which air 7 is introduced as an oxidizing agent. Fuel 5 is now sprayed into the combustion chamber through the fuel inlet port 3. The flow direction of the fuel 5 is indicated by arrows 9. An inert gas 6 is simultaneously injected through the inert gas inlet port 4 into the combustion chamber so that the inert gas 6 shields the fuel 5 from the air 7 present in the combustion chamber. The flow direction of the inert gas is indicated by arrows 8.

It can be seen from FIG. 1 that the fuel 5 has no direct contact with the air 7 in the vicinity of the fuel nozzle 1. In fact there is an inert gas layer 6 between the fuel 5 and the air 7, which means that the oxygen in the air 7 as an oxidizer cannot reach the fuel 5. Therefore, no ignitable mixture of fuel 5 and air 7 can form in the vicinity of the fuel nozzle 1.

The inert gas used can be, for example, nitrogen, carbon dioxide, a noble gas or a mixture of these substances. The fuel can be, among other things, petroleum, natural gas, but also hydrogen. It is also possible for the fuel to be already mixed with an oxidizing agent, e.g. air, in an amount which cannot result in ignition.

FIG. 2 shows the fuel nozzle 1 described in connection with FIG. 1 in a cross section perpendicular to the longitudinal axis 11. The cross section through the housing 2, through the fuel inlet port 3 and through the inert gas inlet port 4 can be seen in FIG. 2. The fuel inlet port 3 has a circular cross section and is located in the center of the fuel nozzle 1. Alternatively, the cross section of the fuel inlet port 3 can also have any other shape. The inert gas inlet port 4 is disposed around the fuel inlet port 3 in an annular manner. Fuel 5 can be injected into the combustion chamber through the fuel inlet port 3. An inert gas, as described in connection with FIG. 1, can be injected into the combustion chamber through the inert gas inlet port 4.

A second exemplary embodiment will now be described in greater detail with reference to FIGS. 1 and 3. The elements from FIG. 3 which correspond to elements already described in connection with the first embodiment are provided with the same reference characters and will not be re-described.

The longitudinal section through the inventive fuel nozzle of this exemplary embodiment corresponds to the longitudinal section through the fuel nozzle 1 described in connection with the first exemplary embodiment and shown in FIG. 1. However, the fuel nozzle 1 of this exemplary embodiment differs in respect of its cross section from the fuel nozzle 1 described in the first exemplary embodiment. FIG. 3 shows the cross section perpendicular to the longitudinal axis 11 of the fuel nozzle 1. In FIG. 3 can be seen the housing 2 of the fuel nozzle 1 which incorporates a centrally disposed fuel inlet port 3 and inert gas inlet ports 10 disposed in an annular manner around the fuel inlet port 3. The fuel inlet port 3 again has a circular cross section. However, the cross section can also have any other shape.

The individual inert gas inlet ports 10 shown in FIG. 3 each have a circular cross section. They are disposed concentrically around the fuel inlet port 3 in an annular manner. Alternatively to the circular cross section shown in FIG. 3, the inert gas inlet ports 10 can also have any other cross sectional shape.

Apart from the differing cross section, the mode of operation of the fuel nozzle described in this exemplary embodiment corresponds to the fuel nozzle described in connection with the first exemplary embodiment.

Although in the present exemplary embodiment the inert gas outlet port completely encircles the fuel outlet port or more precisely the inert gas inlet ports are evenly distributed around the fuel outlet port, it is basically also possible that the inert gas outlet port only partially encircles the fuel outlet port or the inert gas outlet ports are unevenly distributed around the fuel outlet port. This variant is particularly suitable if the oxidizing agent is also unevenly distributed in the combustion chamber.

As a further variant it is possible to vary, via its circumference, the radial dimension of the annular inert gas inlet port described in the first exemplary embodiment in order to equalize an uneven distribution of the oxidizing agent in the combustion chamber.

All in all, the present invention is characterized in that it effectively protects the burner from excessively high temperatures while at the same time enabling the spatial position of the ignition and the flame to be controlled.

1.-11. (canceled)

12. A method for protecting a burner from excessive heating during combustion of a fuel in a combustion chamber, comprising:
injecting the fuel through a fuel nozzle at the same time as an inert gas is injected into the combustion chamber in an area around the injected fuel,
wherein until an ignitable mixture is produced, the fuel is spatially separated from an oxidizer by the inert gas,
wherein the inert gas is injected into the combustion chamber through an inlet port annularly encircling a fuel inlet port of the fuel nozzle such that a stream of fuel is completely enclosed by a shroud of inert gas,
wherein a first flow direction of the fuel and a second flow direction of the inert gas are essentially parallel to the fuel inlet port, and
wherein the oxidizer is injected into the combustion chamber at a spatial distance from the fuel nozzle to produce the ignitable mixture thereby enabling both a flame and a spatial position of a mixing zone to be controlled.

13. The method as claimed in claim 12, wherein the inert gas is selected from the group consisting of nitrogen, steam, carbon dioxide, a noble gas and a combination thereof.

14. The method as claimed in claim 12, wherein hydrogen is used as the fuel.

15. A fuel nozzle, comprising:
a fuel inlet port which is encircled by an inert gas inlet port,
wherein by injecting an inert gas through the inert gas inlet port, the fuel is spatially separated from an oxidizer,
wherein the inert gas is injected into the combustion chamber through the inert gas inlet port annularly encircling the fuel inlet port of the fuel nozzle so that the stream of fuel is completely enclosed by a shroud of inert gas,
wherein a first flow direction of the fuel and a second flow direction of the inert gas are essentially parallel to the fuel inlet port, and
wherein the oxidizer is injected into the combustion chamber at a spatial distance from the fuel nozzle to produce an ignitable, mixture thereby enabling both a flame and a spatial position of a mixing zone to be controlled.

16. The fuel nozzle as claimed in claim 15, wherein the fuel inlet port is encircled by the inert gas inlet port in an annular manner.

17. The fuel nozzle as claimed in claim 16, wherein the fuel inlet port is encircled by the inert gas inlet port in a concentric manner.

18. The fuel nozzle as claimed in claim 15, wherein the inert gas inlet port comprises of a plurality of individual ports disposed around the fuel inlet port.

19. The fuel nozzle as claimed in claim 18, wherein each of the plurality of individual ports include a circular cross section.

20. The fuel nozzle as claimed in claim 15, wherein the oxidizer is air.

21. The fuel nozzle as claimed in claim 15, wherein the inert gas is selected from the group consisting of nitrogen, steam, carbon dioxide, a noble gas and a combination thereof.

22. The fuel nozzle as claimed in claim 15, wherein the fuel inlet port is circular in cross section.

23. A burner, comprising:
a fuel nozzle, comprising:
a fuel inlet port which is encircled by an inert gas inlet port,
wherein by injecting an inert gas through the inert gas inlet port, the fuel is spatially separated from an oxidizer,
wherein the inert gas is injected into the combustion chamber through the inert gas inlet port annularly encircling the fuel inlet port of the fuel nozzle so that the stream of fuel is completely enclosed by a shroud of inert gas,
wherein a first flow direction of the fuel and a second flow direction of the inert gas are essentially parallel to the fuel inlet port, and
wherein the oxidizer is injected into the combustion chamber at a spatial distance from the fuel nozzle to produce an ignitable, mixture thereby enabling both a flame and a spatial position of a mixing zone to be controlled.

24. The burner as claimed in claim 23, wherein the fuel inlet port is encircled by the inert gas inlet port in an annular manner.

25. The burner as claimed in claim 24, wherein the fuel inlet port is encircled by the inert gas inlet port in a concentric manner.

26. The burner as claimed in claim 23, wherein the inert gas inlet port comprises of a plurality of individual ports disposed around the fuel inlet port.

27. The burner as claimed in claim 26, wherein each of the plurality of individual ports include a circular cross section.

28. The burner as claimed in claim 23, wherein the oxidizer is air.

29. The burner as claimed in claim 23, wherein the fuel inlet port is circular in cross section.

30. The burner as claimed in claim 23, wherein the burner is used by a gas turbine.

31. The burner as claimed in claim 23, wherein the inert gas is selected from the group consisting of nitrogen, steam, carbon dioxide, a noble gas and a combination thereof.
